(19) United States
(12) Patent Application Publication
(10) Pub. No.: US 2024/0321504 A1
(43) Pub. Date: Sep. 26, 2024

(54) COIL INDUCTOR, POWER CONVERTING SYSTEM, AND METHOD FOR FORMING THE SAME

(71) Applicant: INMICRO TECHNOLOGY LTD., Xiamen (CN)

(72) Inventors: Weixiang YU, Xiamen (CN); Fujian DING, Xiamen (CN)

(73) Assignee: INMICRO TECHNOLOGY LTD., Xiamen (CN)

(21) Appl. No.: 18/144,900

(22) Filed: May 9, 2023

Related U.S. Application Data
(63) Continuation of application No. PCT/CN2023/083084, filed on Mar. 22, 2023.

(51) Int. Cl. H01F 27/28; H01F 27/02

(52) U.S. Cl. CPC H01F 27/2804; H01F 27/027; H01F 2027/2809

(57) ABSTRACT

A coil inductor includes a plurality of conductive coils stacking in a first direction. The coil inductor includes a topmost conductive coil including a first portion extending in a second direction perpendicular to the first direction and a second portion extending in the first direction, a bottommost conductive coil including a third portion extending in the second direction and a fourth portion extending in the first direction, and at least one intermediate conductive coil extending in the second direction and disposed between the topmost conductive coil and the bottommost conductive coil.

### CROSS REFERENCE TO RELATED APPLICATIONS

This application is a continuation of International Application No. PCT/CN2023/083084, filed on Mar. 22, 2023, entitled “COIL INDUCTOR, POWER CONVERTING SYSTEM, AND METHOD FOR FORMING THE SAME,” which is hereby incorporated by reference in its entirety.

### BACKGROUND

The present disclosure relates to coil inductors, power converting systems, and methods for forming coil inductors.

The coil inductors are generally used for electrical applications, which can be categorized into radio frequency (RF) inductors used for signal processing, and power inductors for power supply lines. In the application of RF inductors, the coil inductors may be used for choking, blocking, attenuating, or filtering/smoothing high frequency noise in electrical circuits. In the application of power inductors, the power inductors form part of the voltage conversion circuit in a DC-DC converter or other device. For example, a power inductor is used in a step-up, step-down, or step-up/step-down circuit to convert a certain voltage to the required voltage.

### SUMMARY

In one aspect, a coil inductor is disclosed. The coil inductor includes a plurality of conductive coils stacking in a first direction. The coil inductor includes a topmost conductive coil including a first portion extending in a second direction perpendicular to the first direction and a second portion extending in the first direction, a bottommost conductive coil including a third portion extending in the second direction and a fourth portion extending in the first direction, and at least one intermediate conductive coil extending in the second direction and disposed between the topmost conductive coil and the bottommost conductive coil.

In another aspect, a coil inductor is disclosed. The coil inductor includes a plurality of conductive coils stacking in a first direction and a magnetic body covering the plurality of conductive coils. The conductive coils include a topmost conductive coil extending in a second direction perpendicular to the first direction, a bottommost conductive coil extending in the second direction, and at least one intermediate conductive coil extending in the second direction and disposed between the topmost conductive coil and the bottommost conductive coil. A first terminal of the topmost conductive coil and a second terminal of the bottommost conductive coil extend in the first direction.

In still another aspect, a power converting system is disclosed. The power converting system includes a coil inductor configured to convert a source voltage to a required voltage and a controller coupled to the coil inductor and configured to control operations of the coil inductor. The coil inductor includes a plurality of conductive coils stacking in a first direction. The plurality of conductive coils include a topmost conductive coil including a first portion extending in a second direction perpendicular to the first direction and a second portion extending in the first direction, a bottommost conductive coil including a third portion extending in the second direction and a fourth portion extending in the first direction, and at least one intermediate conductive coil extending in the second direction and disposed between the topmost conductive coil and the bottommost conductive coil.

In yet another aspect, a power converting system is disclosed. The power converting system includes a coil inductor configured to convert a source voltage to a required voltage and a controller coupled to the coil inductor and configured to control operations of the coil inductor. The coil inductor includes a plurality of conductive coils stacking in a first direction and a magnetic body covering the plurality of conductive coils. The conductive coils include a topmost conductive coil extending in a second direction perpendicular to the first direction, a bottommost conductive coil extending in the second direction, and at least one intermediate conductive coil extending in the second direction and disposed between the topmost conductive coil and the bottommost conductive coil. A first terminal of the topmost conductive coil and a second terminal of the bottommost conductive coil extend in the first direction.

In yet another aspect, a manufacturing method for forming a coil inductor is disclosed. A bottommost conductive coil including a second terminal is formed. At least one intermediate conductive coil is stacked on the bottommost conductive coil. The intermediate conductive coil is in electric contact with the bottommost conductive coil. A topmost conductive coil including a first terminal is stacked on the intermediate conductive coil. The topmost conductive coil is in electric contact with the intermediate conductive coil. The first terminal and the second terminal are bent. A magnetic body is formed covering the bottommost conductive coil, the intermediate conductive coil, and the topmost conductive coil.

### BRIEF DESCRIPTION OF THE DRAWINGS

The accompanying drawings, which are incorporated herein and form a part of the specification, illustrate aspects of the present disclosure and, together with the description, further serve to explain the present disclosure and to enable a person skilled in the pertinent art to make and use the present disclosure.

FIG. 1 illustrates a perspective view of an exemplary coil inductor, according to some aspects of the present disclosure.

FIG. 2 illustrates a plan view of an exemplary coil inductor, according to some aspects of the present disclosure.

FIG. 3 illustrates a side view of an exemplary coil inductor, according to some aspects of the present disclosure.

FIG. 4 illustrates a perspective view of an exemplary coil inductor, according to some aspects of the present disclosure.

FIG. 5 illustrates a side view of an exemplary coil inductor, according to some aspects of the present disclosure.

FIG. 6 illustrates a side view of an exemplary coil inductor, according to some aspects of the present disclosure.

FIG. 7 illustrates a side view of an exemplary coil inductor, according to some aspects of the present disclosure.

FIG. 8 illustrates a flowchart of an exemplary method for forming a coil inductor, according to some aspects of the present disclosure.

FIG. 9 illustrates a perspective view of an exemplary coil inductor, according to some aspects of the present disclosure.

FIG. 10 illustrates a plan view of an exemplary coil inductor, according to some aspects of the present disclosure.

FIG. 11 illustrates a perspective view of an exemplary coil inductor, according to some aspects of the present disclosure.

FIG. 12 illustrates a perspective view of an exemplary coil inductor, according to some aspects of the present disclosure.

FIG. 13 illustrates a perspective view of an exemplary coil inductor, according to some aspects of the present disclosure.

FIG. 14 illustrates a block diagram of an exemplary power converting system having a coil inductor, according to some aspects of the present disclosure.

The present disclosure will be described with reference to the accompanying drawings.

### DETAILED DESCRIPTION

Although specific configurations and arrangements are discussed, it should be understood that this is done for illustrative purposes only. As such, other configurations and arrangements can be used without departing from the scope of the present disclosure. Also, the present disclosure can also be employed in a variety of other applications. Functional and structural features as described in the present disclosures can be combined, adjusted, and modified with one another and in ways not specifically depicted in the drawings, such that these combinations, adjustments, and modifications are within the scope of the present discloses.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

It should be readily understood that the meaning of “on,” “above,” and “over” in the present disclosure should be interpreted in the broadest manner such that “on” not only means “directly on” something but also includes the meaning of “on” something with an intermediate feature or a layer therebetween, and that “above” or “over” not only means the meaning of “above” or “over” something but can also include the meaning it is “above” or “over” something with no intermediate feature or layer therebetween (i.e., directly on something).

Further, spatially relative terms, such as “beneath,” “below,” “lower,” “above,” “upper,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations), and the spatially relative descriptors used herein may likewise be interpreted accordingly.

As used herein, the term “layer” refers to a material portion including a region with a thickness. A layer can extend over the entirety of an underlying or overlying structure or may have an extent less than the extent of an underlying or overlying structure. Further, a layer can be a region of a homogeneous or inhomogeneous continuous structure that has a thickness less than the thickness of the continuous structure. For example, a layer can be located between any pair of horizontal planes between, or at, a top surface and a bottom surface of the continuous structure. A layer can extend horizontally, vertically, and/or along a tapered surface. A substrate can be a layer, can include one or more layers therein, and/or can have one or more layer thereupon, thereabove, and/or therebelow. A layer can include multiple layers. For example, an interconnect layer can include one or more conductor and contact layers (in which interconnect lines and/or via contacts are formed) and one or more dielectric layers.

As used herein, the term “coil” refers to a structure consisting of something wound in a continuous series of loops. The shape of the coil may be circle, square, rectangle, oval, triangle or any polygon. The coil may be wound or moved in a spiral course. In some implementations, the coil is a generic name for an electrode in the shape of a spiral. In some implementations, an inductor may also be called a coil. The inductor is a passive two-terminal electrical component that stores energy in a magnetic field when electric current flows through it. An inductor typically consists of an insulated wire wound into a coil.

The inductance of a circuit depends on the geometry of the current path as well as the magnetic permeability of nearby materials. The inductor may consist of a wire or other conductor shaped to increase the magnetic flux through the circuit, usually in the shape of a coil or helix, with two terminals. Winding the wire into a coil increases the number of times the magnetic flux lines link the circuit, increasing the field and, thus, the inductance. The more turns, the higher the inductance. The inductance also depends on the shape of the coil, separation of the turns, and many other factors. By adding a “magnetic core” made of a ferromagnetic material like iron inside the coil, the magnetizing field from the coil will induce magnetization in the material, increasing the magnetic flux. The high permeability of a ferromagnetic core can increase the inductance of a coil by a factor of several thousand over what it would be without it.

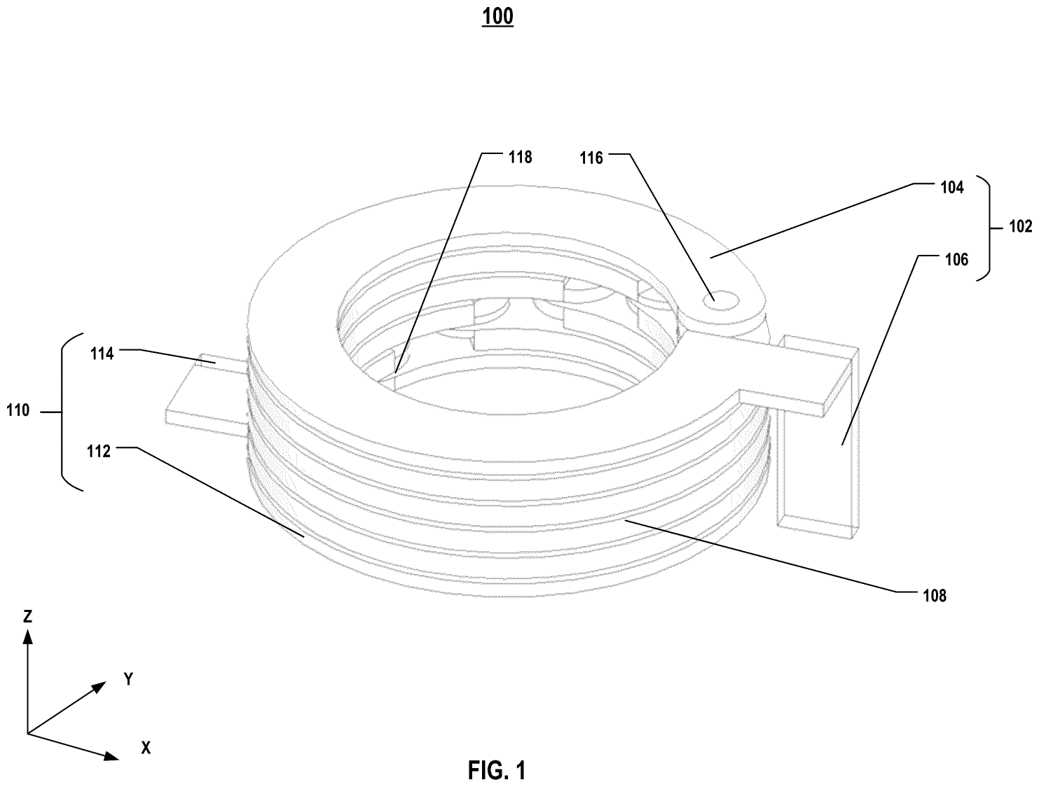

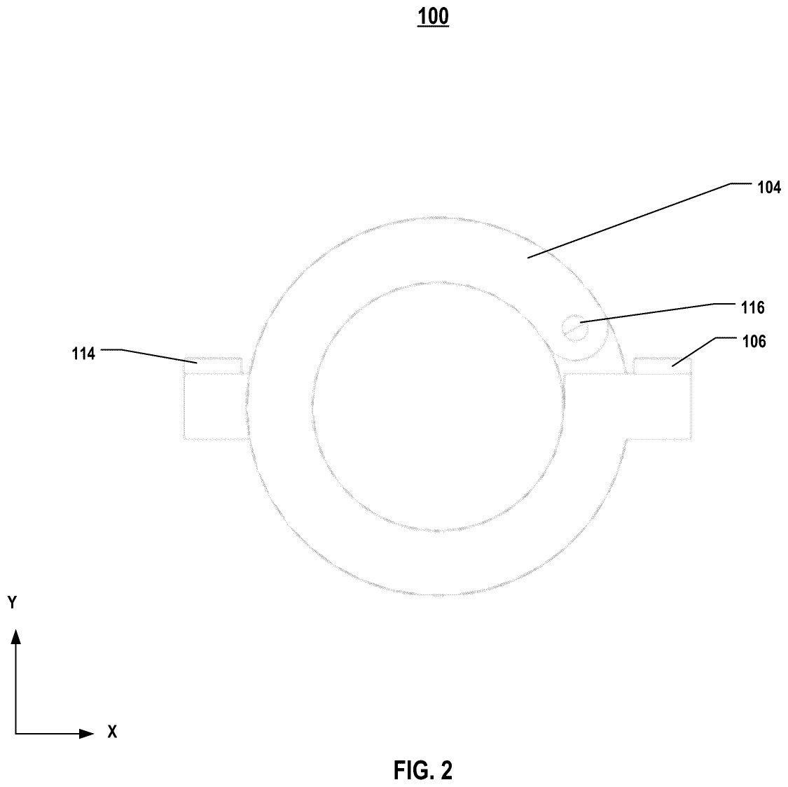

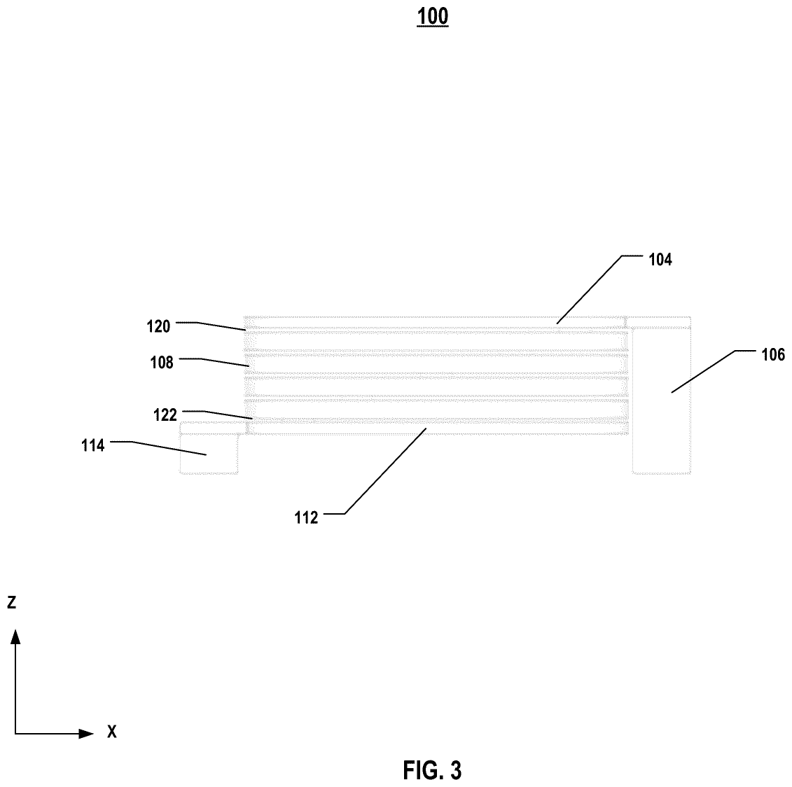

FIG. 1 illustrates a perspective view of an exemplary coil inductor 100, according to some aspects of the present disclosure, FIG. 2 illustrates a plan view of coil inductor 100, according to some aspects of the present disclosure, and FIG. 3 illustrates a side view of coil inductor 100, according to some aspects of the present disclosure. For the purpose of better describing the present disclosure, the perspective view, the plan view, and the side view of coil inductor 100 in FIGS. 1-3 will be discussed together.

As shown in FIGS. 1-3, coil inductor 100 may include a topmost conductive coil 102, a bottommost conductive coil 110, and at least one intermediate conductive coil 108 located between topmost conductive coil 102 and bottommost conductive coil 110. In some implementations, the amount of intermediate conductive coil 108 may be more than one. Topmost conductive coil 102 includes a first portion 104 and a second portion 106. In some implementations, first portion 104 may extend along the X-direction and the Y-direction to form a plane. In some implementations, first portion 104 may be circle, square, rectangle, oval, triangle, or any polygon extending along the X-direction and the Y-direction. Second portion 106 may extend along the Z-direction perpendicular to the X-direction and the Y-direction. In some implementations, second portion 106 may further extend along the X-direction.

In some implementations, the connection of first portion 104 and second portion 106 may be a right angle. In some implementations, the connection of first portion 104 and second portion 106 may be an arc angle. In some implementations, first portion 104 and second portion 106 may be formed by the same material, e.g., a conductive film, or a cooper film, and the conductive film or the cooper film may be bent to form the right angle or the arc angle.

Bottommost conductive coil 110 includes a third portion 112 and a fourth portion 114. In some implementations, third portion 112 may extend along the X-direction and the Y-direction to form a plane. In some implementations, third portion 112 may be circle, square, rectangle, oval, triangle or any polygon extending along the X-direction and the Y-direction. Fourth portion 114 may extend along the Z-direction perpendicular to the X-direction and the Y-direction. In some implementations, fourth portion 114 may further extend along the X-direction.

In some implementations, the connection of third portion 112 and fourth portion 114 may be a right angle. In some implementations, the connection of third portion 112 and fourth portion 114 may be an arc angle. In some implementations, third portion 112 and fourth portion 114 may be formed by the same material, e.g., a conductive film, or a cooper film, and the conductive film or the cooper film may be bent to form the right angle or the arc angle.

In some implementations, coil inductor 100 may include a plurality of intermediate conductive coil 108. In some implementations, each intermediate conductive coil 108 may have the same material and the same structure. In some implementations, each intermediate conductive coil 108 may have a different structure. Intermediate conductive coil 108 may extend along the X-direction and the Y-direction to form a plane. In some implementations, intermediate conductive coil 108 may be circle, square, rectangle, oval, triangle, or any polygon extending along the X-direction and the Y-direction.

In some implementations, first portion 104 of topmost conductive coil 102, third portion 112 of bottommost conductive coil 110, and intermediate conductive coil 108 may have the same shape.

In some implementations, topmost conductive coil 102 is in electric contact with intermediate conductive coil 108 through a first contact 116. In some implementations, bottommost conductive coil 110 is in electric contact with intermediate conductive coil 108 through a second contact 118. In some implementations, first contact 116 and second contact 118 are formed by conductive materials, e.g., cooper. In some implementations, topmost conductive coil 102 and intermediate conductive coil 108 are separated by a first insulation film 120, and first contact 116 penetrates first insulation film 120. In some implementations, bottommost conductive coil 110 and intermediate conductive coil 108 are separated by a second insulation film 122 and second contact 118 penetrates second insulation film 122. It is understood that one topmost conductive coil 102, one bottommost conductive coil 110, and four intermediate conductive coil 108 are shown in FIGS. 1-3 for illustration purposes only, and the inductor structure may have more or less layers of topmost conductive coil 102, bottommost conductive coil 110, and intermediate conductive coil 108 according to different requirements.

In some implementations, topmost conductive coil 102, bottommost conductive coil 110, and intermediate conductive coil 108 may be formed by metal. In some implementations, topmost conductive coil 102, bottommost conductive coil 110, and intermediate conductive coil 108 may be formed by copper films or copper foils. In some implementations, the thickness of topmost conductive coil 102, bottommost conductive coil 110, and intermediate conductive coil 108 may be in a range between 20 micrometers and 100 micrometers. In some implementations, as shown in FIG. 3, a first thickness of topmost conductive coil 102 is less than a second thickness of intermediate conductive coil 108. In some implementations, as shown in FIG. 3, a third thickness of bottommost conductive coil 110 is less than the second thickness of intermediate conductive coil 108.

In some implementations, first insulation film 120 and second insulation film 122 may be formed by nonconductive material. In some implementations, first insulation film 120 and second insulation film 122 may be formed by polyimide films. In some implementations, the thickness of first insulation film 120 and second insulation film 122 may be in a range between 5 micrometers and 50 micrometers. In some implementations, the thickness of first insulation film 120 and second insulation film 122 may be in a range between 15 micrometers and 30 micrometers.

In some implementations, topmost conductive coil 102 may be formed by stacking a plurality of conductive films. In some implementations, bottommost conductive coil 110 may be formed by stacking a plurality of conductive films. In some implementations, intermediate conductive coil 108 may be formed by stacking a plurality of conductive films.

It is understood that, in some implementations, first portion 104 and second portion 106 of topmost conductive coil 102 may have different names. For example, first portion 104 may be called a topmost conductive film, and second portion 106 may be called a first terminal. It is also understood that, in some implementations, third portion 112 and fourth portion 114 of bottommost conductive coil 110 may have different names. For example, third portion 112 may be called a bottommost conductive film, and fourth portion 114 may be called a second terminal.

In some implementations, topmost conductive coil 102, bottommost conductive coil 110, intermediate conductive coil 108, first contact 116, and second contact 118 may be formed by the semiconductor processes, such as lithography operation and electroplating process.

By stacking multiple layers of conductive coils and insulation films, and using lithography operation and electroplating process to form the contacts between adjacent conductive coils, coil inductor 100 may include more coil layers. In addition, by using the thin conductive coils and thin insulation films to form the coil stacks, the thickness of coil inductor 100 may be further reduced.

Furthermore, first portion 104 and second portion 106 of topmost conductive coil 102 may be formed by the same lithography operation and/or electroplating process, and second portion 106 of topmost conductive coil 102 may be bent at a specific angle, e.g., 90 degrees, in a later operation. Similarly, third portion 112 and fourth portion 114 of bottommost conductive coil 110 may be formed by the same lithography operation and/or electroplating process, and fourth portion 114 of bottommost conductive coil 110 may be bent at a specific angle, e.g., 90 degrees, in a later operation.

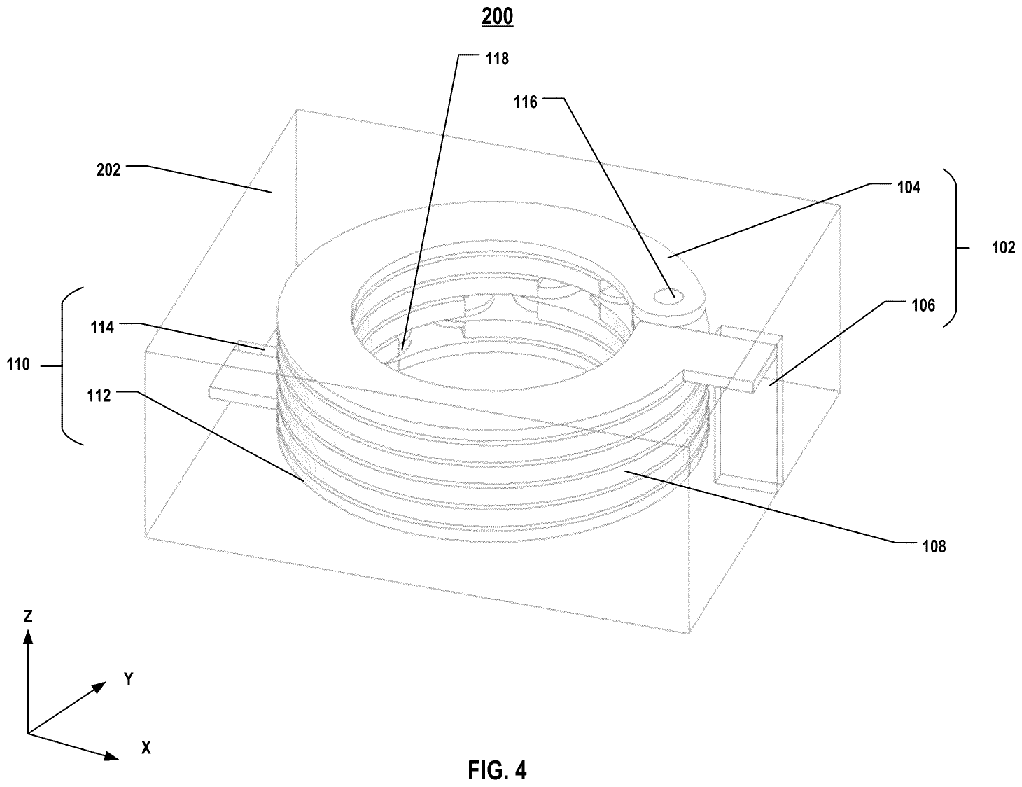

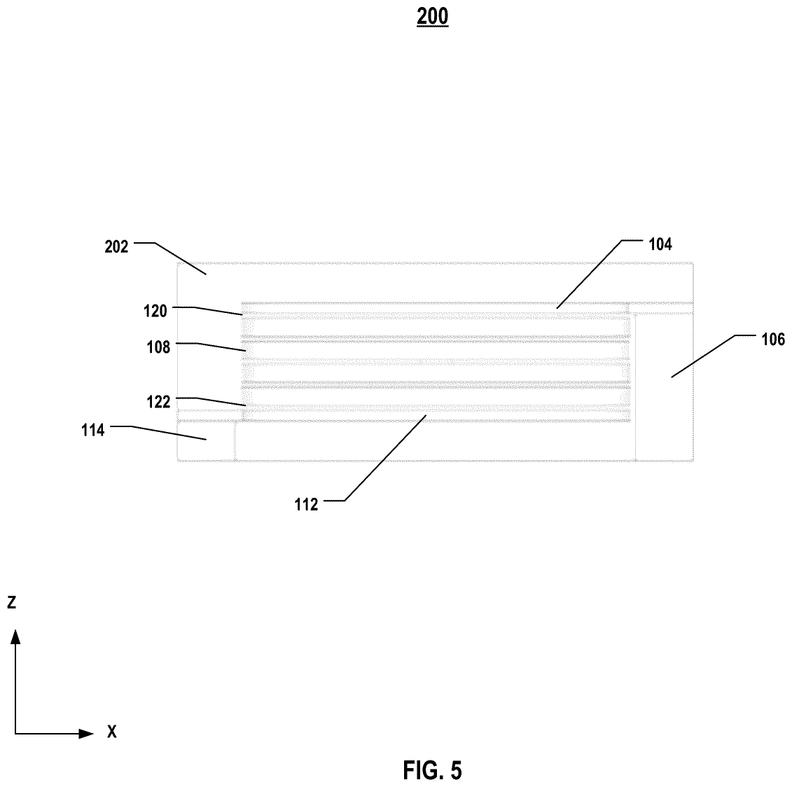

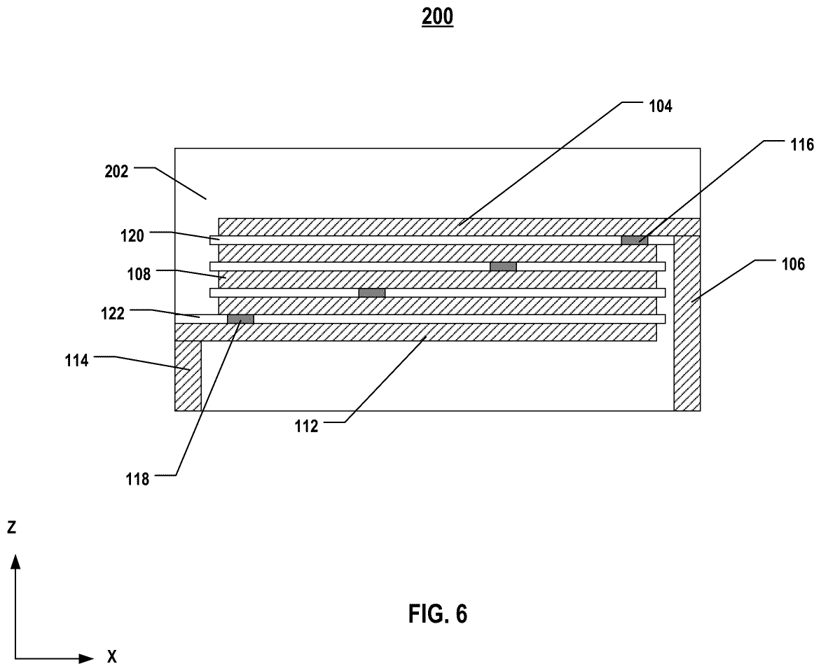

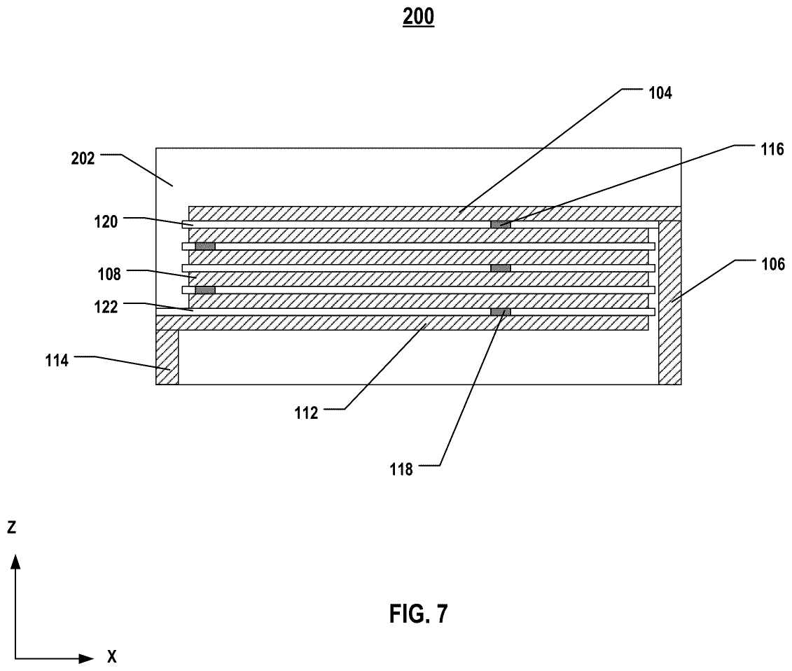

FIG. 4 illustrates a perspective view of an exemplary coil inductor 200, according to some aspects of the present disclosure, FIG. 5 illustrates a side view of coil inductor 200, according to some aspects of the present disclosure, FIG. 6 illustrates a side view of coil inductor 200, according to some aspects of the present disclosure, and FIG. 7 illustrates a side view of coil inductor 200, according to some aspects of the present disclosure. For the purpose of better describing the present disclosure, the perspective view and the side views of coil inductor 200 in FIGS. 4-7 will be discussed together.

In some implementations, coil inductor 200 may have a similar structure and materials to coil inductor 100, but coil inductor 200 is covered by a magnetic body 202. In some implementations, magnetic body 202 may be formed by a mixture of magnetic alloy powders and binders. In some implementations, the mixture may be powder or paste. In some implementations, the mixture may include a ferrite material containing the respective components of Fe, Ni, Zn and/or Cu as main components. In some implementations, the mixture may include a ferrite material containing Ni—Cu—Zn-based ferrite material, Ni—Cu—Zn—Mg-based ferrite material, and/or Ni—Cu-based ferrite material. In some implementations, the mixture may include a ferrite-sintered body.

In some implementations, the plurality of conductive coils and the plurality of insulation films are embedded in the mixture, and the mixture may be baked or cured to solidify to form magnetic body 202. In some implementations, after embedding the plurality of conductive coils and the plurality of insulation films in the mixture, a compression process may be performed on the mixture to enhance the compactness of the mixture, and then the baking process may be performed to solidify the mixture.

As shown in FIGS. 4-7, in some implementations, a top surface of magnetic body 202 is higher than a top surface of topmost conductive coil 102. Specifically, in some implementations, a top surface of magnetic body 202 is higher than a top surface of first portion 104 of topmost conductive coil 102. Further, as shown in FIGS. 4-7, in some implementations, a bottom surface of the magnetic body 202 is lower than a bottom surface of bottommost conductive coil 110. Specifically, in some implementations, a bottom surface of the magnetic body 202 is lower than a bottom surface of third portion 112 of bottommost conductive coil 110.

In some implementations, second portion 106 of topmost conductive coil 102 extends in the Z-direction to the bottom surface of magnetic body 202. In some implementations, fourth portion 114 of bottommost conductive coil 110 extends in the Z-direction to the bottom surface of magnetic body 202.

In some implementations, first contact 116 and second contact 118 may be formed by conductive material. In some implementations, first contact 116 and second contact 118 may be formed by copper. In some implementations, as shown in FIG. 6, first contact 116 and second contact 118 may be unaligned in the side view of coil inductor 100 and/or coil inductor 200. In other words, in the plan view of coil inductor 100 and/or coil inductor 200, first contact 116 and second contact 118 may be nonoverlapped with each other.

In some implementations, as shown in FIG. 7, first contact 116 and second contact 118 may be aligned in the side view of coil inductor 100 and/or coil inductor 200. In other words, in the plan view of coil inductor 100 and/or coil inductor 200, first contact 116 and second contact 118 may be overlapped with each other.

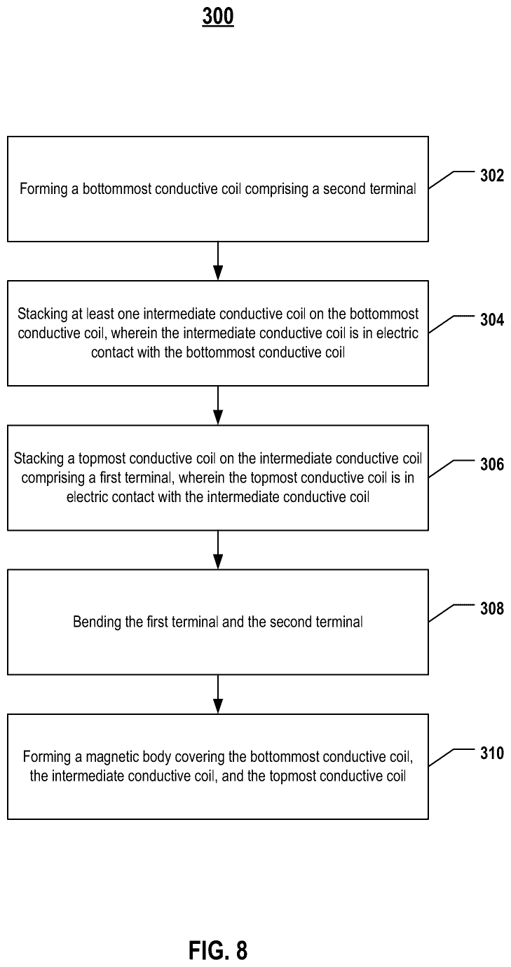

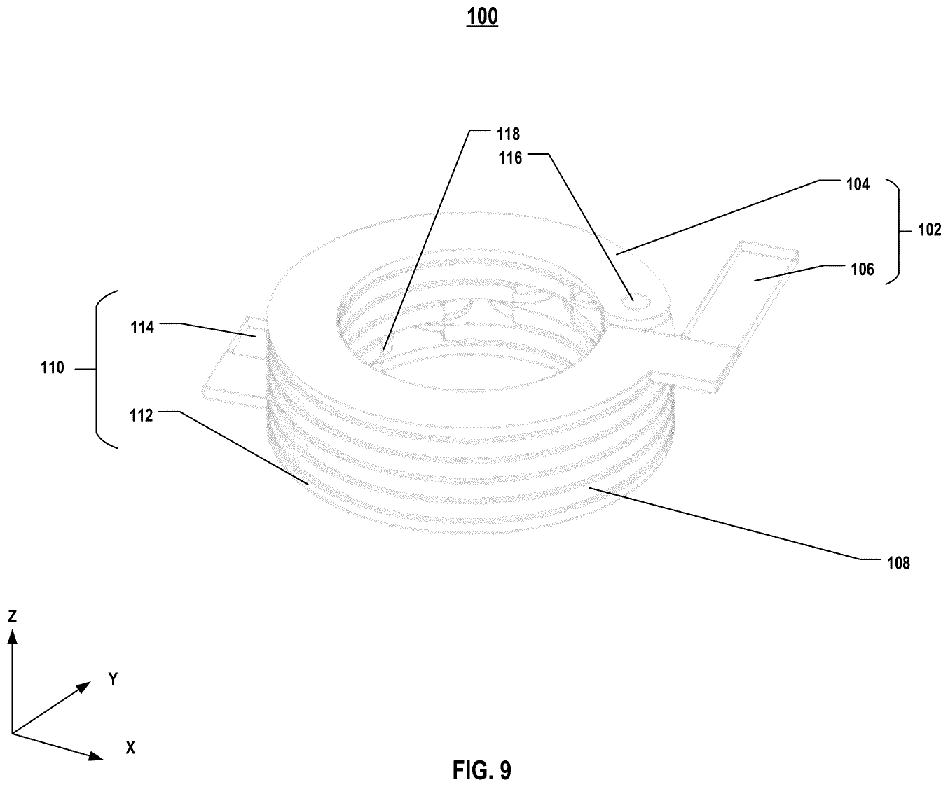

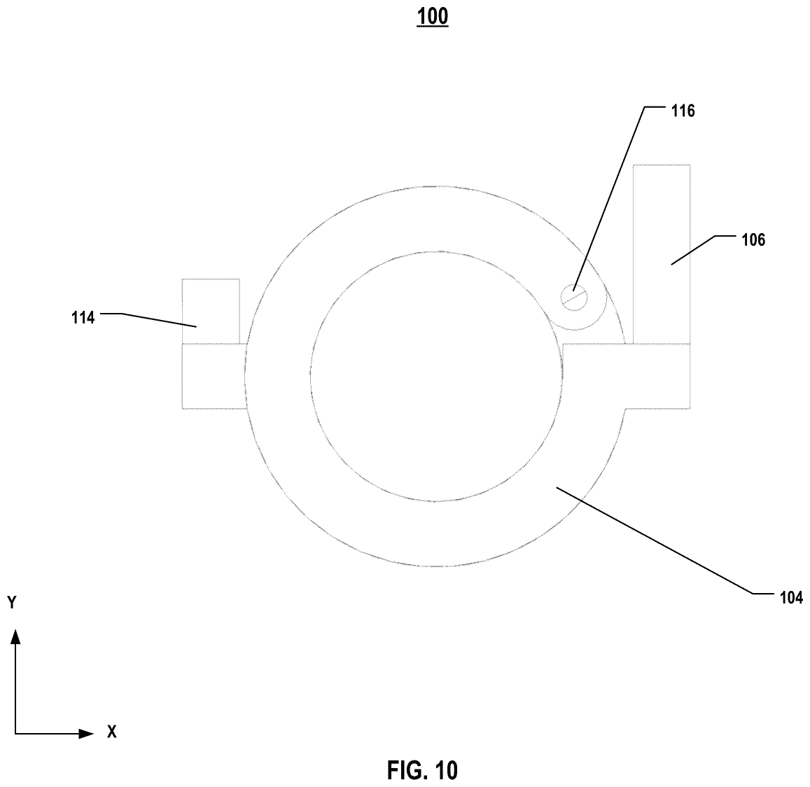

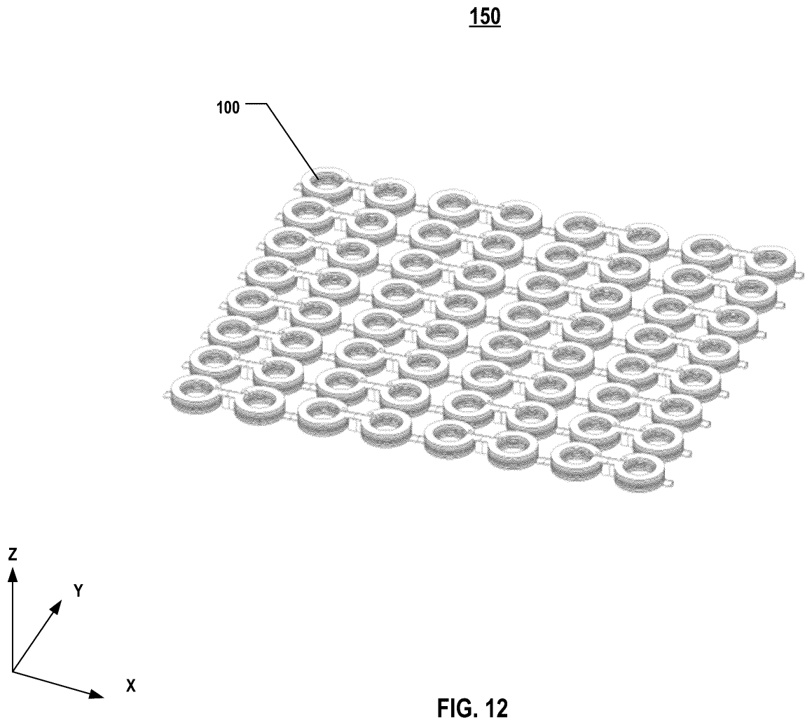

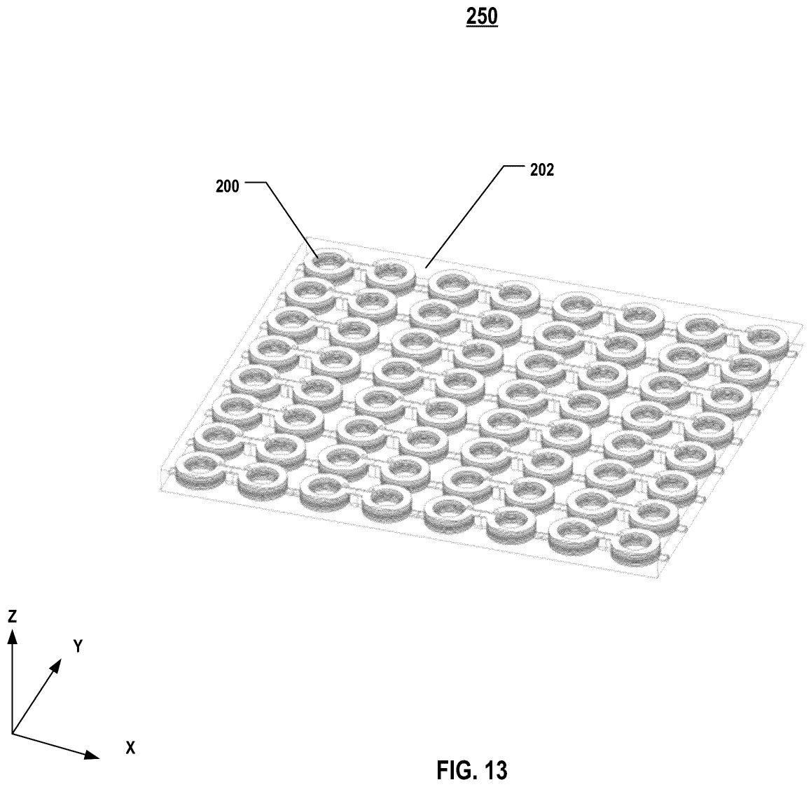

FIG. 8 illustrates a flowchart of an exemplary method 300 for forming coil inductor 100 and/or coil inductor 200, according to some aspects of the present disclosure. FIG. 9 illustrates a perspective view of coil inductor 100, according to some aspects of the present disclosure, FIG. 10 illustrates a plan view of coil inductor 100, according to some aspects of the present disclosure, FIG. 1I illustrates a perspective view of a semi-finished product 150 having multiple coil inductors 100, according to some aspects of the present disclosure, FIG. 12 illustrates a perspective view of semi-finished product 150 having multiple coil inductors 100, according to some aspects of the present disclosure, and FIG. 13 illustrates a perspective view of a semi-finished product 250 having multiple coil inductors 200, according to some aspects of the present disclosure. For the purpose of better describing the present disclosure, method 300 in FIG. 8 and the structures in FIGS. 9-13 will be discussed together.

As shown in operation 302 in FIG. 8, bottommost conductive coil 110 is formed including a bottommost conductive film and a second terminal. In some implementations, the bottommost conductive film and the second terminal, or called third portion 112 and fourth portion 114 of bottommost conductive coil 110, may be formed by the same operations as the same plane. In some implementations, the bottommost conductive film and the second terminal may be formed by the semiconductor processes, such as the lithography operation and electroplating process.

As shown in operation 304 in FIG. 8, at least one intermediate conductive coil 108 is stacked on bottommost conductive coil 110. Intermediate conductive coil 108 is in electric contact with bottommost conductive coil 110 through second contact 118. In some implementations, intermediate conductive coil 108 and second contact 118 may be formed by the semiconductor processes, such as the lithography operation and electroplating process.

As shown in operation 306 in FIG. 8, topmost conductive coil 102 is stacked on intermediate conductive coil 108. Topmost conductive coil 102 may include a topmost conductive film and a first terminal. In some implementations, the topmost conductive film and the first terminal, or called first portion 104 and second portion 106 of topmost conductive coil 102, may be formed by the same operations as the same plane. In some implementations, the topmost conductive film and the first terminal may be formed by the semiconductor processes, such as the lithography operation and electroplating process.

As shown in FIGS. 9-10, after operation 306, coil inductors 100 is formed. In some implementations, the topmost conductive film and the first terminal in FIGS. 9-10 are in the same plane extending along the X-direction and the Y-direction, and the bottommost conductive film and the second terminal in FIGS. 9-10 are in the same plane extending along the X-direction and the Y-direction.

Then, as shown in operation 308 in FIG. 8, the first terminal and the second terminal are bent to a specific angle. In some implementations, the first terminal and the second terminal are bent from a horizontal position to a vertical position. In some implementations, the first terminal and the second terminal are bent 90 degrees, as shown in FIGS. 1-3.

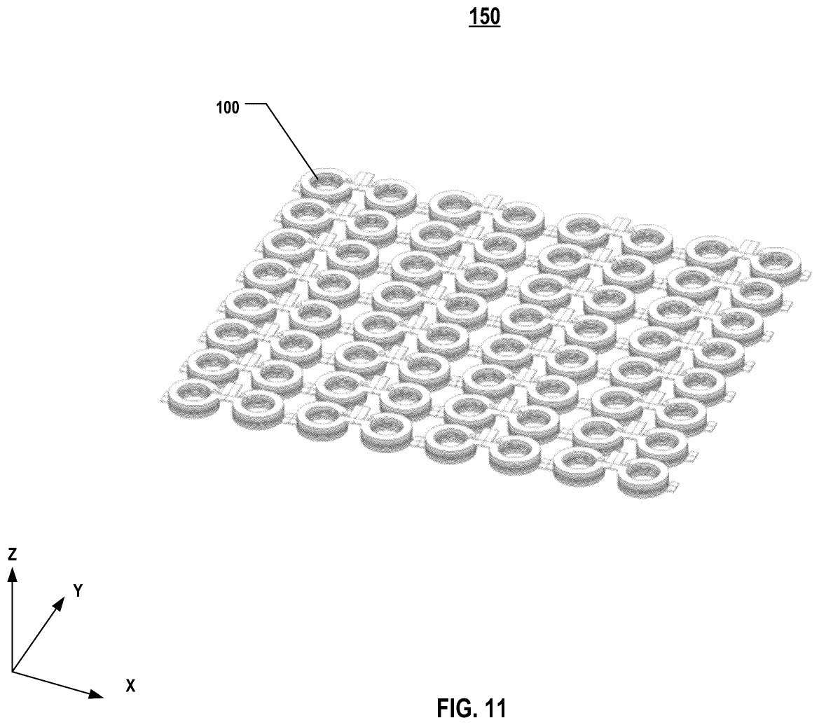

In some implementations, multiple coil inductors 100 may be formed together by stacking multiple conductive films, as shown in FIG. 11. Then, the first terminals and the second terminals in the multiple coil inductors 100 may be bent together, as shown in FIG. 12.

As shown in operation 310 in FIG. 8, magnetic body 202 may be formed to cover coil inductors 100, including bottommost conductive coil 110, intermediate conductive coil 108, and topmost conductive coil 102. As shown in FIG. 13, after covering magnetic body 202 onto multiple coil inductors 100, multiple coil inductors 200 are formed together. In some implementations, multiple coil inductors 200 may be divided to individual devices later.

It is understood that the operations shown in method 300 are not exhaustive and that other operations may be performed as well before, after, or between any of the illustrated operations. Further, some of the operations may be performed simultaneously, or in a different order than shown in FIG. 8. For example, bottommost conductive coil 110, intermediate conductive coil 108, and topmost conductive coil 102 may be formed separately or simultaneously by stacking conductive films, and then bottommost conductive coil 110, intermediate conductive coil 108, and topmost conductive coil 102 are bonded together.

By stacking multiple layers of conductive coils and insulation films, and using lithography operation and electroplating process to form the contacts between adjacent conductive coils, coil inductor 100 may include more coil layers. In addition, by using the thin conductive coils and thin insulation films to form the coil stacks, the thickness of coil inductor 100 may be further reduced.

Furthermore, first portion 104 and second portion 106 of topmost conductive coil 102 may be formed by the same lithography operation and/or electroplating process, and second portion 106 of topmost conductive coil 102 may be bent at a specific angle, e.g., 90 degrees, in a later operation. Similarly, third portion 112 and fourth portion 114 of bottommost conductive coil 110 may be formed by the same lithography operation and/or electroplating process, and fourth portion 114 of bottommost conductive coil 110 may be bent at a specific angle, e.g., 90 degrees, in a later operation.

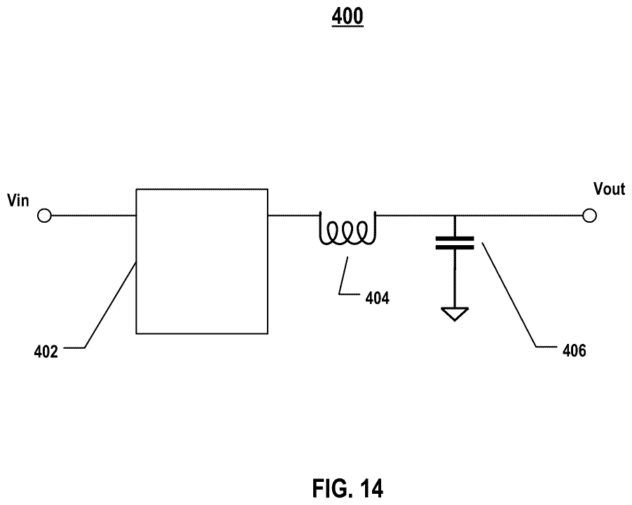

FIG. 14 illustrates a block diagram of an exemplary power converting system 400 having a coil inductor, according to some aspects of the present disclosure. In some implementations, power converting system 400 is a DC-DC converter. In some implementations, power converting system 400 may be applied to various power supply circuits. For example, the processor, memory, LEDs, and other devices require many different DC voltages to run, and power converting system 400 may adjust these differences in voltages. Hence, power converting system 400 is required in most electronic devices, and typically, a large number of them are used in a device.

Power converting system 400 may include a controller 402, a coil inductor 404, and a capacitor 406. Coil inductor 404 may be configured to convert a source voltage Vin to a required voltage Vout. Controller 402 may be coupled to coil inductor 404 and may be configured to control operations of coil inductor 404. Coil inductor 404 may work with capacitor 406 to play the role of rectifying the rectangular wave output from control 402 to a direct current.

According to one aspect of the present disclosure, a coil inductor is disclosed. The coil inductor includes a plurality of conductive coils stacking in a first direction. The coil inductor includes a topmost conductive coil including a first portion extending in a second direction perpendicular to the first direction and a second portion extending in the first direction, a bottommost conductive coil including a third portion extending in the second direction and a fourth portion extending in the first direction, and at least one intermediate conductive coil extending in the second direction and disposed between the topmost conductive coil and the bottommost conductive coil.

In some implementations, the first portion of the topmost conductive coil, the third portion of the bottommost conductive coil, and the intermediate conductive coil further extend in a third direction perpendicular to the first direction and the second direction.

In some implementations, the topmost conductive coil is in electric contact with the intermediate conductive coil through a first contact, and the bottommost conductive coil is in electric contact with the intermediate conductive coil through a second contact.

In some implementations, the topmost conductive coil and the intermediate conductive coil are separated by a first insulation film, and the first contact penetrates the first insulation film, and the bottommost conductive coil and the intermediate conductive coil are separated by a second insulation film and the second contact penetrates the second insulation film.

In some implementations, the first insulation film and the second insulation film include a polyimide film. In some implementations, the topmost conductive coil, the bottommost conductive coil, and the intermediate conductive coil include a copper film.

In some implementations, the coil inductor further includes a magnetic body covering the plurality of conductive coils. In some implementations, a top surface of the magnetic body is higher than a top surface of the topmost conductive coil. In some implementations, a bottom surface of the magnetic body is lower than a bottom surface of the third portion of the bottommost conductive coil.

In some implementations, the second portion of the topmost conductive coil extends in the first direction to the bottom surface of the magnetic body, and the fourth portion of the bottommost conductive coil extends in the first direction to the bottom surface of the magnetic body.

In some implementations, the magnetic body is formed by a mixture of a magnetic alloy powder and a binder.

In some implementations, a first thickness of the topmost conductive coil is less than a second thickness of the intermediate conductive coil, and a third thickness of the bottommost conductive coil is less than the second thickness of the intermediate conductive coil.

In some implementations, each of the plurality of conductive coils includes a plurality of conductive films.

According to another aspect of the present disclosure, a coil inductor is disclosed. The coil inductor includes a plurality of conductive coils stacking in a first direction and a magnetic body covering the plurality of conductive coils. The conductive coils include a topmost conductive coil extending in a second direction perpendicular to the first direction, a bottommost conductive coil extending in the second direction, and at least one intermediate conductive coil extending in the second direction and disposed between the topmost conductive coil and the bottommost conductive coil. A first terminal of the topmost conductive coil and a second terminal of the bottommost conductive coil extend in the first direction.

In some implementations, the topmost conductive coil includes a topmost conductive film and the first terminal perpendicular to the topmost conductive film, and the bottommost conductive coil includes a bottommost conductive film and the second terminal perpendicular to the bottommost conductive film.

In some implementations, the first terminal extends in the first direction to a bottom surface of the magnetic body, and the second terminal extends in the first direction to the bottom surface of the magnetic body.

In some implementations, the topmost conductive coil, the bottommost conductive coil, and the intermediate conductive coil further extend in a third direction perpendicular to the first direction and the second direction.

In some implementations, the topmost conductive coil is in electric contact with the intermediate conductive coil through a first contact, and the bottommost conductive coil is in electric contact with the intermediate conductive coil through a second contact.

In some implementations, the topmost conductive coil and the intermediate conductive coil are separated by a first insulation film, and the first contact penetrates the first insulation film, and the bottommost conductive coil and the intermediate conductive coil are separated by a second insulation film and the second contact penetrates the second insulation film.

In some implementations, the first insulation film and the second insulation film include a polyimide film.

In some implementations, the first contact overlaps the second contact in a plan view of the coil inductor.

In some implementations, the topmost conductive coil, the bottommost conductive coil, and the intermediate conductive coil comprise a copper film.

In some implementations, a first thickness of the topmost conductive coil is less than a second thickness of the intermediate conductive coil, and a third thickness of the bottommost conductive coil is less than the second thickness of the intermediate conductive coil.

According to a further aspect of the present disclosure, a power converting system is disclosed. The power converting system includes a coil inductor configured to convert a source voltage to a required voltage and a controller coupled to the coil inductor and configured to control operations of the coil inductor. The coil inductor includes a plurality of conductive coils stacking in a first direction. The plurality of conductive coils include a topmost conductive coil including a first portion extending in a second direction perpendicular to the first direction and a second portion extending in the first direction, a bottommost conductive coil including a third portion extending in the second direction and a fourth portion extending in the first direction, and at least one intermediate conductive coil extending in the second direction and disposed between the topmost conductive coil and the bottommost conductive coil.

According to still a further aspect of the present disclosure, a power converting system is disclosed. The power converting system includes a coil inductor configured to convert a source voltage to a required voltage and a controller coupled to the coil inductor and configured to control operations of the coil inductor. The coil inductor includes a plurality of conductive coils stacking in a first direction and a magnetic body covering the plurality of conductive coils. The conductive coils include a topmost conductive coil extending in a second direction perpendicular to the first direction, a bottommost conductive coil extending in the second direction, and at least one intermediate conductive coil extending in the second direction and disposed between the topmost conductive coil and the bottommost conductive coil. A first terminal of the topmost conductive coil and a second terminal of the bottommost conductive coil extend in the first direction.

According to still a further aspect of the present disclosure, a manufacturing method for forming a coil inductor is disclosed. A bottommost conductive coil including a second terminal is formed. At least one intermediate conductive coil is stacked on the bottommost conductive coil. The intermediate conductive coil is in electric contact with the bottommost conductive coil. A topmost conductive coil including a first terminal is stacked on the intermediate conductive coil. The topmost conductive coil is in electric contact with the intermediate conductive coil. The first terminal and the second terminal are bent. A magnetic body is formed covering the bottommost conductive coil, the intermediate conductive coil, and the topmost conductive coil.

In some implementations, the first terminal and the second terminal are bent from a horizontal position to a vertical position.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described exemplary implementations, but should be defined only in accordance with the following claims and their equivalents.

What is claimed is:

1. A coil inductor, comprising:
a plurality of conductive coils stacking in a first direction, comprising:
a topmost conductive coil comprising a first portion extending in a second direction perpendicular to the first direction and a second portion extending in the first direction;
a bottommost conductive coil comprising a third portion extending in the second direction and a fourth portion extending in the first direction; and
at least one intermediate conductive coil extending in the second direction and disposed between the topmost conductive coil and the bottommost conductive coil.

2. The coil inductor of claim 1, wherein the first portion of the topmost conductive coil, the third portion of the bottommost conductive coil, and the intermediate conductive coil further extend in a third direction perpendicular to the first direction and the second direction.

3. The coil inductor of claim 1, wherein the topmost conductive coil is in electric contact with the intermediate conductive coil through a first contact, and the bottommost conductive coil is in electric contact with the intermediate conductive coil through a second contact.

4. The coil inductor of claim 3, wherein the topmost conductive coil and the intermediate conductive coil are separated by a first insulation film and the first contact penetrates the first insulation film, and the bottommost conductive coil and the intermediate conductive coil are separated by a second insulation film and the second contact penetrates the second insulation film.

5. The coil inductor of claim 4, wherein the first insulation film and the second insulation film comprise a polyimide film.

6. The coil inductor of claim 1, wherein the topmost conductive coil, the bottommost conductive coil, and the intermediate conductive coil comprise a copper film.

7. The coil inductor of claim 1, further comprising:
a magnetic body covering the plurality of conductive coils.

8. The coil inductor of claim 7, wherein a top surface of the magnetic body is higher than a top surface of the topmost conductive coil.

9. The coil inductor of claim 7, wherein a bottom surface of the magnetic body is lower than a bottom surface of the third portion of the bottommost conductive coil.

10. The coil inductor of claim 9, wherein the second portion of the topmost conductive coil extends in the first direction to the bottom surface of the magnetic body, and the fourth portion of the bottommost conductive coil extends in the first direction to the bottom surface of the magnetic body.

11. The coil inductor of claim 7, wherein the magnetic body is formed by a mixture of a magnetic alloy powder and a binder.

12. The coil inductor of claim 1, wherein a first thickness of the topmost conductive coil is less than a second thickness of the intermediate conductive coil, and a third thickness of the bottommost conductive coil is less than the second thickness of the intermediate conductive coil.

13. The coil inductor of claim 1, wherein each of the plurality of conductive coils comprises a plurality of conductive films.

14. A coil inductor, comprising:
a plurality of conductive coils stacking in a first direction, comprising:
a topmost conductive coil extending in a second direction perpendicular to the first direction;
a bottommost conductive coil extending in the second direction; and
at least one intermediate conductive coil extending in the second direction and disposed between the topmost conductive coil and the bottommost conductive coil; and
a magnetic body covering the plurality of conductive coils,
wherein a first terminal of the topmost conductive coil and a second terminal of the bottommost conductive coil extend in the first direction.

15. The coil inductor of claim 14, wherein the topmost conductive coil comprises a topmost conductive film and the first terminal perpendicular to the topmost conductive film, and the bottommost conductive coil comprises a bottommost conductive film and the second terminal perpendicular to the bottommost conductive film.

16. The coil inductor of claim 14, wherein the first terminal extends in the first direction to a bottom surface of the magnetic body, and the second terminal extends in the first direction to the bottom surface of the magnetic body.

17. The coil inductor of claim 14, wherein the topmost conductive coil, the bottommost conductive coil, and the intermediate conductive coil further extend in a third direction perpendicular to the first direction and the second direction.

18. The coil inductor of claim 14, wherein the topmost conductive coil is in electric contact with the intermediate conductive coil through a first contact, and the bottommost conductive coil is in electric contact with the intermediate conductive coil through a second contact.

19. The coil inductor of claim 18, wherein the topmost conductive coil and the intermediate conductive coil are separated by a first insulation film and the first contact penetrates the first insulation film, and the bottommost conductive coil and the intermediate conductive coil are separated by a second insulation film and the second contact penetrates the second insulation film.

20. A power converting system, comprising:
a coil inductor configured to convert a source voltage to a required voltage, the coil inductor comprising:
a plurality of conductive coils stacking in a first direction, comprising:
a topmost conductive coil comprising a first portion extending in a second direction perpendicular to the first direction and a second portion extending in the first direction;
a bottommost conductive coil comprising a third portion extending in the second direction and a fourth portion extending in the first direction; and
at least one intermediate conductive coil extending in the second direction and disposed between the topmost conductive coil and the bottommost conductive coil; and
a controller coupled to the coil inductor and configured to control operations of the coil inductor.
